(19) United States
(12) Patent Application Publication
(10) Pub. No.: US 2004/0137898 A1
(43) Pub. Date: Jul. 15, 2004

(54) Geospatial lightwave communications system

(76) Inventors: William F. Crandall JR., Sausalito, CA (US); William B Loughborough, Goldendale, WA (US); C Ward Bond, Baton Rouge, LA (US)

Correspondence Address: SIEBERTH & PATTY, 2924 BRAKLEY DRIVE SUITE A 1, BATON ROUGE, LA, 70816

(21) Appl. No.: 10/471,791

(22) PCT Filed: Mar. 18, 2002
(86) PCT No.: PCT/US02/08396

(51) Int. Cl. H04Q 7/20

(52) U.S. Cl. 455/426.2

(57) ABSTRACT

A system for communicating label specific information which comprises a communication network (20) in communication with a computer database (18), at least one transceiver (10), and a plurality of labels (12). Each label (12) is disposed on an object in the environment with which a unique identification code is associated and is configured and is configured to transmit a lightwave signal (A) indicative of the code. The transceiver (10) is configured to receive the lightwave signal (A), process the lightwave signal (A) to obtain the code, communicate through the communication network (20) with the computer database (18) to download information associated with the unique identification code obtained and communicate the information to a user.

### BACKGROUND

“Location based” services are currently delivered in the outside environment through hand-held devices such as cell phones, personal digital assistants (PDA), monitors installed in vehicles and the like. This information is made available to a variety of end users. For example, a driver can get an image of a map indicating his or her location, or a delivery person can get directions on how to drive to a desired location.

Current global positioning systems (GPS) include receivers which only work where satellite transmitters can reach, thus limiting the system's use to the outdoor environment. Even here, overhead and surrounding obstructions such as trees and urban corridors result in spotty service. For optimum resolution, the user must have an open view to the sky. Also, location based service applications which require accuracy to within meters are not possible because of limitations in GPS resolution.

Altitude measures in GPS are much more inaccurate than latitude/longitude. Also, cellular telephone triangulation, based upon measurements of the cell phone's relative distance from multiple cell towers, fails to provide any measure of altitude. Therefore, even if current cellular technology could eventually be developed to the point that it could locate a cell phone or PDA inside a building accurately, it would not provide the altitude information needed to determine the floor on which the user is located. In other words, when using GPS alone, the user (or others) could know his or her location on the X and Y-axes, but not on the Z-axis. Overall spatial resolution of this system is therefore limited to tens of meters.

The investment necessary to maintain these complex and energy intensive location based service communication systems—even without the exact spatial resolution required for significant numbers of applications—are high, and this trend is continuing.

At their best, implementations of location based services would provide “just in time information” delivery of information where it is needed, when it is needed, in the language required and tailored to the recipient. However, in a great number of situations, where the user may want to identify one among many objects or destinations in the immediate environment, currently available systems lack specificity in terms of spatial accuracy (precision in location information) needed for a person to, e.g., receive a menu while standing in front of a restaurant, receive hypertext information about a particular object they are viewing in a museum, or receive extended information about signs they see—but cannot read—in a transit terminal. This is a limitation of current location based services—the inability to provide spatial selectability (that is, the inability to choose one among many features in the environment for identification). One present method of transmitting information locally is based upon the Infrared Data Association (IrDA) infrared communication protocol. However, this protocol was designed specifically for local, sub-meter device-to-device communication (such as notebook computer-to-PDA or PDA-to-PDA communication) and not as an integrated component of a communication network. Since IrDA does not anticipate closely spaced, multiple transmitters operating concurrently, the protocol is unsophisticated in terms of network collision arbitration. Therefore, IrDA is not a good candidate for communications strategy in the task of facilitating label based services where gathering information at a convenient distance (from one of a number of overhead signs in an airport terminal, for example) may be desired. Generally, IrDA implementations do not anticipate operation in bright sunlight, thus further reducing the medium's effective range in the outdoors.

Currently, an environmental labeling system, Remote Infrared Audible Signs (RIAS) such as that marketed under the trademark TALKING SIGNS®, allows blind and print-disabled users to locate and identify landmarks, signs and facilities of interest. It uses short speech messages stored in infrared transmitters as labels. The user's hand-held receiver converts the transmission from lightwave signals to audible speech messages. The receiver is especially designed for relative uniformity of sensitivity indoors or outdoors. The infrared beam pattern provides control of range (from several centimeters to over 30 meters) and breadth (an angle of from 6 degrees to 360 degrees) for the message coverage. The high degree of spatial selectivity of the RIAS receiver results from the nature of the transmitted frequency modulated (FM) infrared light signals where FM phase lock loop demodulation ensures that only the strongest among many possibly competing signals will be passed to the user. The strongest signal in this regard means the signal which has the most signal energy at the receiver and is the result of three factors: (1) the relative power output of competing transmitters, (2) the relative distance from the competing transmitters to the receiver, and (3) the angle of the receiver's lightwave detector relative to each of the competing transmitters; the angle of the receiver being the most prominent factor controlling which label's information is passed to the receiver.

Many of the existing systems fail to provide the following advantages: three-dimensional locating ability, ease of maintenance in regard to energy needs, just-in-time information for specific locations or objects in the immediate environment, systems in which multiple transmitters do not preclude specific choices of one out of many, facilitation of easy updating of information, or remote transmission of large amounts of data to pinpoint locations.

Thus, a need exists for a wireless communication system which allows the users to associate large amounts of information with a specific target and to update that information on an ongoing basis without experiencing interference from multiple transmission devices and with ease of power system maintenance.

### SUMMARY OF THE INVENTION

It has been recognized that information to be presented to the user can be stored (1) within the transmitting labeling system itself, (2) within the receiver carried by the user (“flash” memory, CD ROM, etc.) or (3) within some wireless server system communicating with the receiver. If the user seeks additional information to that initially provided by the system, some method of selecting from the contents of a database is required. Label based information is specific to each place or object of interest to the user. This means that the totality of information potentially available to the user, visiting many objects, could be enormous and potentially updated on a moment-by-moment basis. A high bandwidth requirement for communicating voice and graphics to the user is another consideration. For these reasons, a hybrid approach of using light (for directionality/selectivity) and radio frequency (for communication speed/wide availability) in providing label based information is needed. The present invention is deemed to meet the foregoing needs, among others, since the present invention implements, in one embodiment, a high resolution label based services system which takes advantage of existing underground wired systems, wireless area networks and/or wireless telecom services such as, for example, a cellular telephone network.

One embodiment of the invention comprises a communication network in communication with a computer database, at least one transceiver, and a plurality of labels. Each label is (i) disposed on an object in the environment with which a unique identification code is associated, wherein the object is either stationary or moving or sometimes stationary and sometimes moving, and (ii) is configured to transmit at least one lightwave signal indicative of the unique identification code. The transceiver is configured to receive at least one lightwave signal, to process the lightwave signal to obtain the unique identification code, and to communicate through the communications network with the computer database to download information associated with the unique identification code obtained. In an embodiment of the invention, the transceiver is characterized by being portable by hand or otherwise accompanying the user. The transceiver is further configured to at least communicate the information associated with the unique identification code to a user. In one embodiment of this invention the communication network is a telecommunication network. In another embodiment of this invention the communication network is a wireless area network. Wireless area network is understood to mean a wireless network which is dedicated to a specific area or location and which may be independent from a telecommunication network.

In another embodiment of the invention the label is further configured to obtain electrical power from either (a) electrical mains wiring, (b) an energy storage/production device, or (c) and energy storage device inoperable combination with a photovoltaic device and to remain dormant until receiving an activating signal from the transceiver. The transceiver is further configured to transmit the activating signal to the label to cause the label to be active.

Another embodiment of the invention comprises a method for enabling communication of label-specific information through a communications network in communication with a computer server. The method comprises (a) designating a plurality of specific objects in an environment by disposing a plurality of labels, each label being (i) disposed at a location in the environment with which a unique identification code is associated, wherein the object is either stationary or moving or sometimes stationary and sometimes moving, and (ii) configured to transmit at least one lightwave signal indicative of the unique identification code; (b) providing at least one mobile transceiver adapted to receive the lightwave signal indicative of the unique identification code, to process the lightwave signal to obtain the unique identification code, and to communicate through the telecommunication network with the server; and (c) providing to the server a computer database configured to correlate the unique identification code with information specific to the respective object in the environment, the server being accessible through the communications network and configured to download the specific information correlated with the respective object from the database to the at least one transceiver. The method further comprises configuring the at least one transceiver to communicate downloaded specific information for the respective object to a user. The method still further comprises configuring the transceiver to communicate with the user by (I) displaying the information on a graphic display, (II) communicating the information by generating an audible signal, (III) tactile representation or (IV) any two or more of the foregoing. In one embodiment of this invention the communication network is a telecommunication network. In another embodiment of this invention the communication network is a wireless area network.

Another embodiment of the invention comprises a method for communicating label-specific information through a communication network. The method comprises (A) transmitting a lightwave signal indicative of a unique identification code by at least one of a plurality of labels, each label being disposed at a location in the environment with which the unique identification code is associated, wherein the object is either stationary or moving or sometimes stationary and sometimes moving; (B) receiving the lightwave signal by at least one transceiver from the at least one label, each transceiver being configured to process the lightwave signal to obtain the unique identification code; (C) transmitting a first radio frequency signal by the at least one transceiver to a computer network comprised of at least one computer server, the first radio frequency signal being indicative of the unique identification code, and the at least one transceiver and the computer network being in wireless radio communication; (D) receiving the first radio frequency signal by the at least one server of the computer network from the at least one transceiver, the at least one server being configured to (1) obtain the unique identification code from the first radio frequency signal, (2) process the unique identification code to link the at least one server to a computer database having information associated with the unique identification number, and (3) obtain the information from the database; (E) transmitting a second radio frequency signal by the at least one server to the at least one transceiver, which second radio frequency signal is indicative of processed database information associated with the object in the environment; and (F) receiving the second radio frequency signal by the at least one transceiver from the at least one server, wherein the at least one transceiver is configured to obtain the processed database information from the second radio frequency signal and to cause the processed database information to be communicated to a user. In one embodiment of this invention the communication network is a telecommunication network. In another embodiment of this invention the communication network is a wireless area network.

Other embodiments, features, and advantages of this invention will be still further apparent from the ensuing description and appended claims.

### BRIEF DESCRIPTION OF THE DRAWINGS

FIG. 1 is a schematic illustration of one embodiment of the invention in which the computer server is at a remote location from the label.

FIG. 1A is a schematic illustration of one embodiment of the invention in which the computer server is at a remote location from the label, and the transceiver is capable of activating the label.

FIG. 2 is a schematic illustration of one embodiment of the invention in which the computer server is located proximate to the label i.e., within the same structure.

FIG. 2A is a schematic illustration of one embodiment of the invention in which the computer server is located proximate to the label i.e., within the same structure, and wherein the transceiver is capable of activating the label.

FIG. 3 is a block diagram of one embodiment of the invention.

FIG. 3A is a block diagram of one embodiment of the invention wherein the transceiver is capable of activating the label.

FIG. 4 is a block diagram of one embodiment of the invention wherein the transceiver is depicted.

FIG. 4A is a block diagram of one embodiment of the invention wherein the transceiver is depicted as being capable of activating the label.

In each of the above figures, like numerals are used to refer to like or functionally like parts among the several figures.

### DETAILED DESCRIPTION OF THE INVENTION

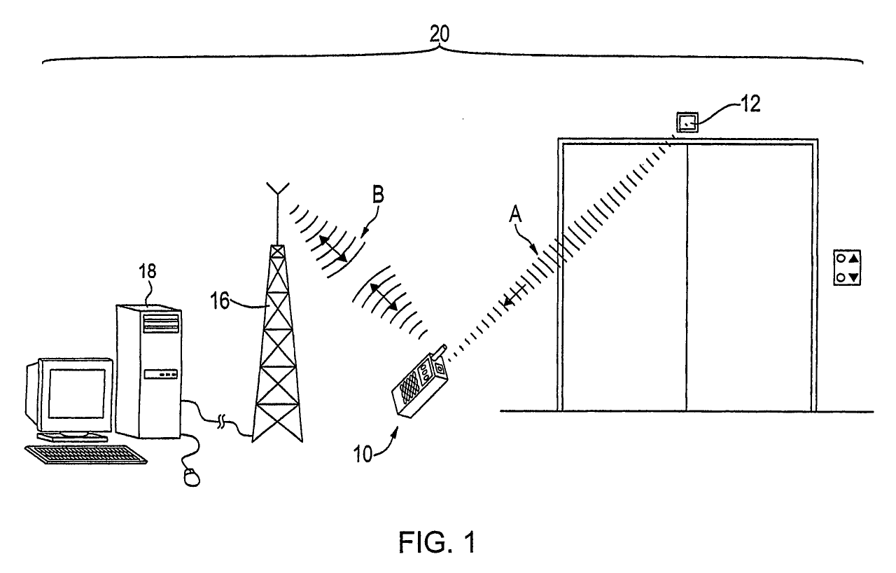

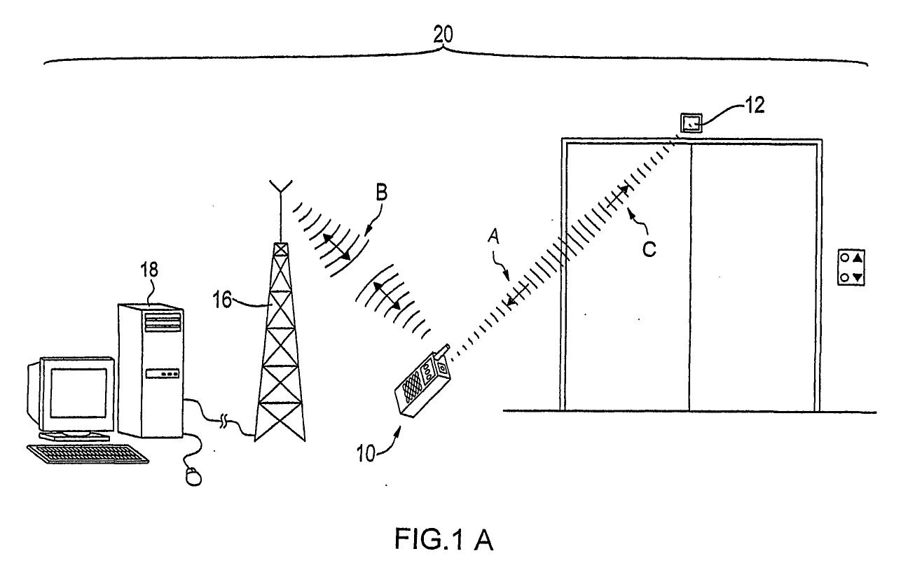

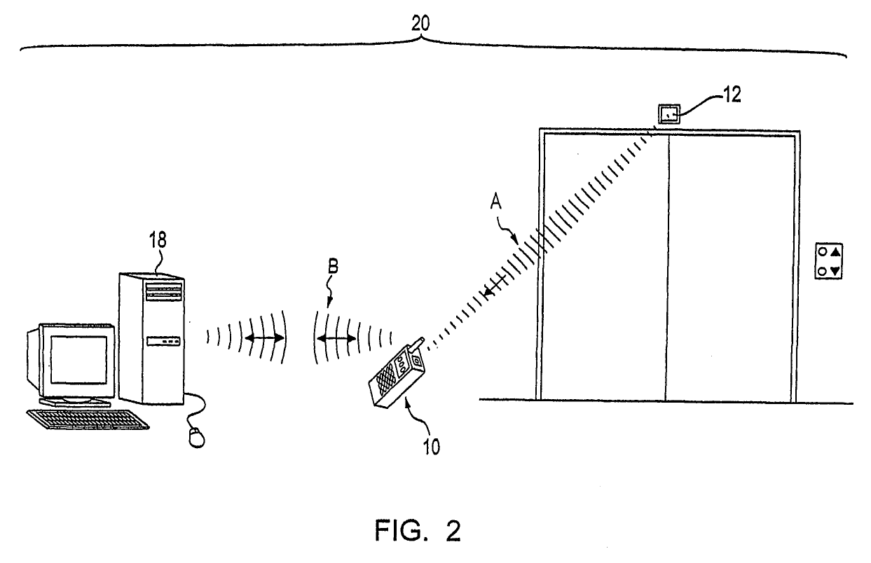

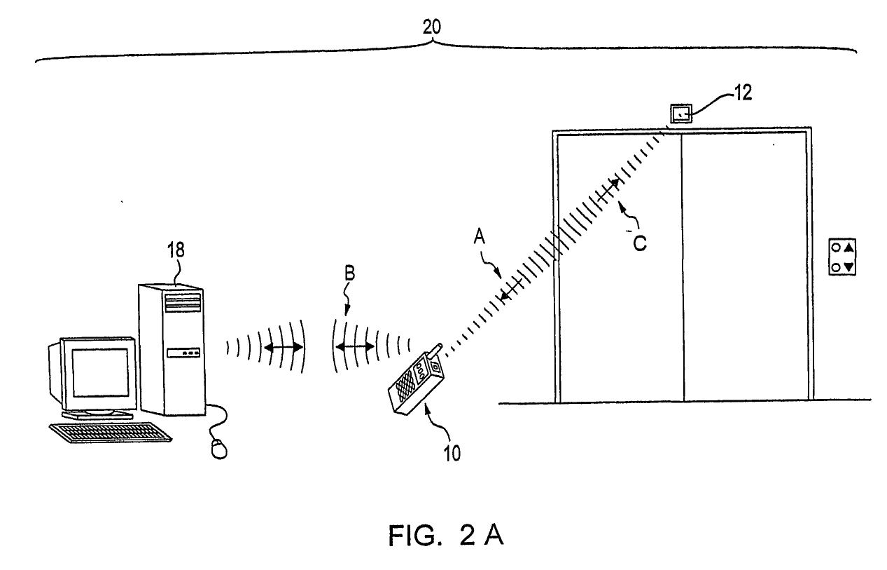

The attached FIG. 1 illustrates one embodiment of this invention for a telecommunication system 20 wherein a wireless lightwave radio frequency transceiver 10 receives a lightwave signal A containing a unique identification code, which is associated with a particular object or location within an environment, from a label 12, configured to transmit signal A containing the identification code, where label 12 has a relatively stronger signal as compared with other like labels in the environment. Labels 12 are preferably infrared labels such as those transmitters marketed under TALKING SIGNS® and further described in at least U.S. Pat. No. 5,757,530. These TALKING SIGNS® labels are configured to transmit lightwave signals which convey information for non-visual display. Labels 12 are preferably infrared spoken message labels. Labels 12 are disposed at key points throughout the environment. The unique identification code pinpoints the label's exact location to a wireless lightwave transceiver 10. This identification code is used to automatically index into location based services information enabling these services to be invoked by a user for any one among many (labeled) features in the environment regardless of the close grouping of the labels in either an indoor or outdoor location. Transceiver 10 (such as a wireless phone or PDA) is configured to receive the transmitted lightwave signal A and process this signal to obtain the embedded code. Transceiver 10 is further configured to wirelessly transmit and receive radio frequency signals B to and from a telecommunication tower 16 which is in communication with a computer server 18 which contains at least one computer database. Computer server 18, represented in FIGS. 1 and 2 as a single computer is understood to be either a single computer configured for wireless communication or an area network of computers configured for wireless communication.

In an embodiment of this invention, wireless server 18 is a system of linkage to other servers commonly known as the World Wide Web. Server 18 and transceiver 10 interface by transmitting information using radio frequency signal B. Server 18 can access the computer database, download information specific to the processed unique identification code from this database to transceiver 10, either from a computer database housed in its own memory or from one or more computer databases found at sites accessed on the World Wide Web. In one embodiment the processed unique identification code transmitted by transceiver 10 to server 18 is itself a Universal Resource Locator (URL) which links to specific web sites containing the needed database information. The processed unique identification code can also automatically index into location based services information on server 18. Transceiver 10 is configured to communicate the downloaded location based services information from server 18 to a user. The information communicated is specific to label 12 which transmitted the lightwave signal A. The manner in which the communication of information is carried out can be by transceiver 10 displaying the information as graphical text or symbols on a graphics display which can be a component of transceiver 10 or the communication of the information can be accomplished by transceiver 10 generating an audible speech message or both.

It is to be understood that transceiver 10 is configured to at least communicate through telecommunication network 20 with a computer database accessible by server 18. Communicate, in this context, at least means that transceiver 10 can upload the unique identification code to the computer database through telecommunication network 20 where information associated with the unique identification code is obtained and the associated information is downloaded onto transceiver 10.

FIG. 2 depicts an embodiment of the invention wherein communication system 20 is a wireless area network and server 18 is a computer network such as a local area network which can be housed within the same environment as disposed labels 12.

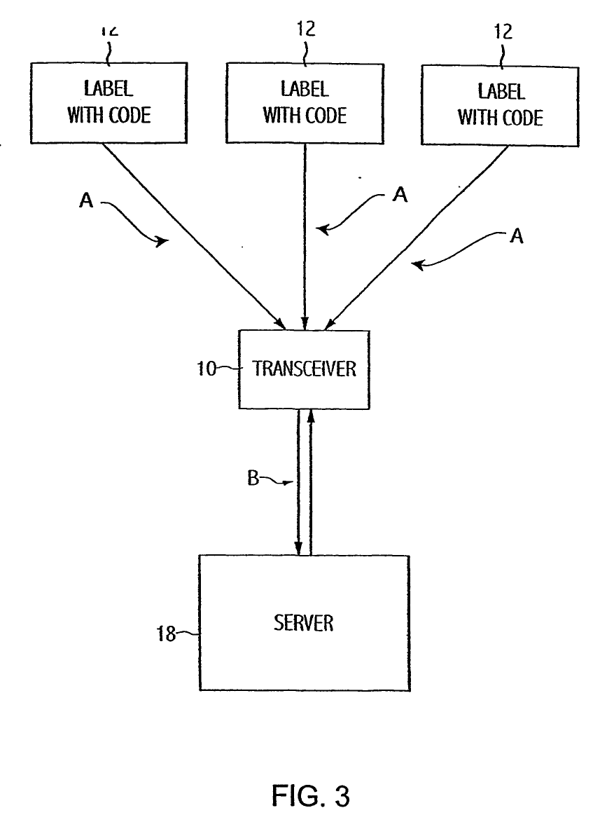

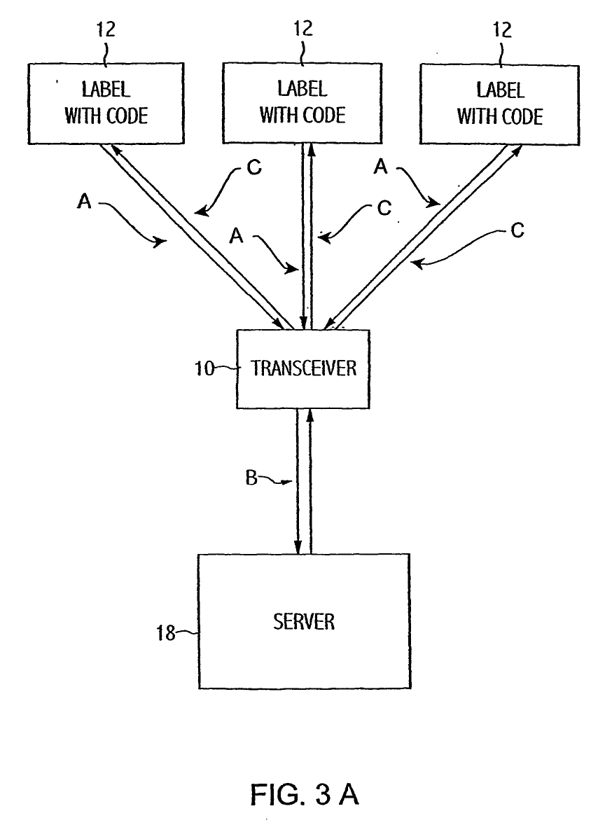

FIG. 3 is a block diagram which demonstrates the relationship of the elements of communication system 20. In one embodiment as depicted, three labels 12,12,12 are disposed within an environment. Each label 12 repeatedly transmits a lightwave signal such as an IR signal A, which indicates a unique location based identification code for that particular object or location within the environment. Transceiver 10, capable of receiving multiple IR signals A from different labels 12,12,12, processes one IR signal A to obtain the unique identification code for a particular label 12. Which IR signal A will be processed by transceiver 10 at any given time will be determined at least by 3 interactive factors: (1) the relative power output of competing labels 12,12,12, (2) the relative distance from the competing labels 12,12,12 to transceiver 10, and (3) the angle of the lightwave detector of transceiver 10 relative IR signal A of each of competing labels 12,12,12. For example, a user holding transceiver 10 which is a PDA can adjust factor (3) to point the PDA at one particular label 12 and ensure that IR signal A of that label 12 will be processed.

Transceiver 10 communicates the unique identification code through a wireless area network using radio frequency (RF) signal B to server 18. As shown in FIG. 3, the bi-directional nature of the radio frequency communication allows an effective interface between transceiver 10 and server 18. This interface allows communication of the unique identification code from transceiver 10 to server 18 where the code will either index to a database residing on server 18, within the area network of server 18, or provide a URL address for accessing a specific web site on the World Wide Web, or both. Once the indexing is accomplished, location based information relevant to the location or other characteristics of label 12 can be downloaded from server 18 to transceiver 10 using RF signal B. The term download is intended to include all necessary computer protocols and/or computer routines and sub-routines which enable of sharing of the desired information between server 18 and transceiver 10. This downloaded information can then be communicated to the user in some desirable manner, such as, by an illuminated graphical display of transceiver 10, by transceiver 10 causing an audible signal such as an audible speech signal or audible sound to be generated, by a tactile representation such as Braille, or some combination of the three.

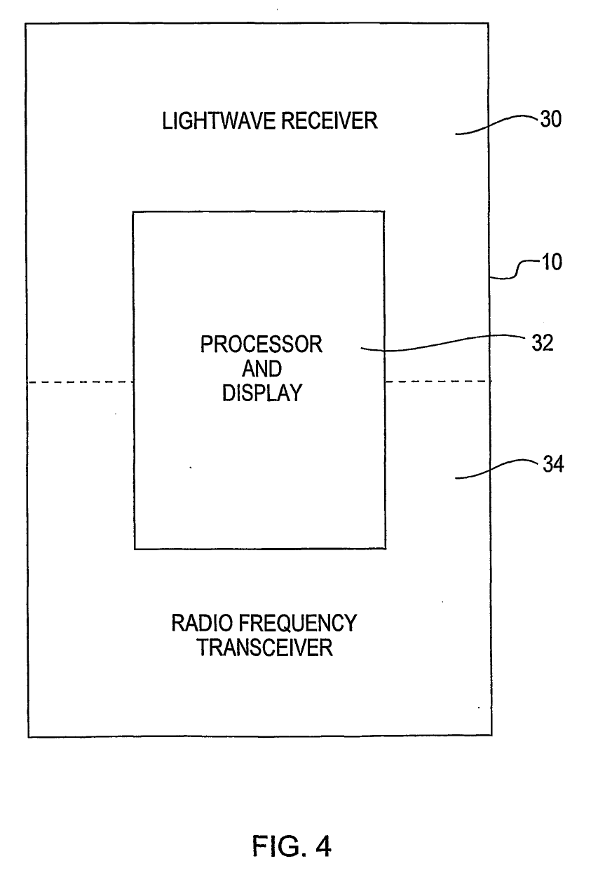

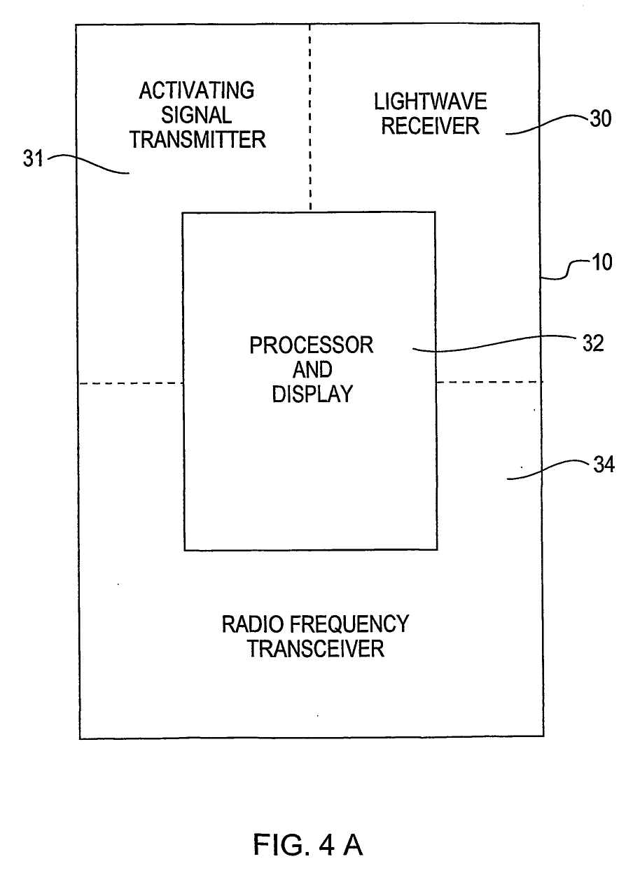

Referring to FIG. 4, which depicts and embodiment of the invention, portable transceiver 10 can be handheld or in some other manner be caused to accompany the user. Transceiver 10 can be equipped with components or modules, such as lightwave receiver 30 for receiving, for example, analog (e.g., Frequency Shift Keying—FSK) code. Processor/display component 32 of transceiver 10, decodes signal A being transmitted from label 12 (not shown) where label 12 identifies objects or destinations in the environment, or other information. The code processed by component 32 is then available to radio frequency transceiver module 34. Radio frequency transceiver module 34 provides transceiver 10 with the capability to interface with server 18 (not shown).

As previously discussed, these highly accurate, pinpointed, unique identification codes can use any of a multitude of wireless networks (e.g., IEEE802.11X), Bluetooth, or wireless packet telecom protocols (e.g., GPRS). These codes, thus acquired, can act as database addresses to call up the location-based information from either servers available through telecommunications, a local server or, by using the unique identification code as the universal resource locator (URL), directly access location-based information stored on sites of the World Wide Web that are linked to the unique identification code the hand-held transceiver has received. In this way, the end user may operate hand-held transceiver 10 to receive the transmitted unique identification code from label 12, whereupon hand-held transceiver 10 downloads customized information specific to that label for display and use by the end user. Lightwave receiver module 30 of transceiver 10 can be the receiver of TALKING SIGNS®, as previously discussed.

This system is usable by both sighted and blind persons. The embodiment of this invention that best serves the blind can be appreciated by understanding that label 12, which transmits the lightwave signal bearing the unique location code, can also transmit interspersed repeating audible messages to lightwave receiver module 30 as seen in FIG. 4. The repeating audible messages are also indicative of the location of each particular label 12, whether label 12 is stationary or moving.

In some cases, as when the communication system is to be used to provide information in temporary settings (such as, for example, temporary commercial exhibits or in cases where label 12 is moving in the environment), the power can be supplied by portable means, such as replaceable, rechargeable devices (i.e., for example, batteries or fuel cells). Also, where illumination is adequate to provide sufficient energy to generate the necessary power to operate the labels, photovoltaic devices in combination with energy storage devices can be employed.

The power requirements of label 12 for transmitting the unique identification code is minimal when the user is located at a convenient range from label 12 (for example, approaching an overhead sign in an airport). Another factor reducing the power requirement for label 12 is that the short bursts of code need not be transmitted more than twice per second. Power consumption is further reduced if label 12 is in an inactive, non-transmitting mode until information from label 12 is requested. As may be appreciated from FIGS. 1A, 2A, 3A and 4A, in one embodiment of this invention label 12 can be configured to obtain electrical power from either the electrical mains wiring of the object or location within the environment, by an energy storage/energy production device, such as a battery, or by an energy storage device in operable communication with a photovoltaic device. Label 12 remains dormant until it receives an activating signal C from modified transceiver 10. In the embodiments of the invention, as shown in FIGS. 1A, 2A and 3A, this is accomplished by configuring both the circuit of label 12 and the circuit of transceiver 10 so that transceiver 10 is capable of sending an activating signal C (an interrogation signal) to the label, thereby setting label 12 into its active, transmission mode. Activating signal C may be either lightwave or radio frequency in nature. FIG. 4A depicts an embodiment of the invention wherein transceiver 10 can be seen as having both lightwave receiver module 30 and an activating signal transmitter module 31.

This invention is susceptible to considerable variation in its practice. Therefore the foregoing description is not intended to limit, and should not be construed as limiting, the invention to the particular exemplifications presented hereinabove.

1. A system comprised of a communication network in communication with a computer database, at least one transceiver, and a plurality of labels, each label being (i) disposed on an object the environment with which a unique identification code is associated, wherein the object is either stationary or moving or at times stationary and at times moving, and (ii) configured to transmit at least one lightwave signal indicative of the unique identification code, whereby the at least one transceiver is configured to receive the at least one lightwave signal, to process the lightwave signal to obtain the unique identification code, and to communicate through the communication network with the computer database to download information associated with the unique identification code obtained.

2. The system in accordance with claim 1 wherein the communication network is a telecommunication network.

3. The system in accordance with claim 2 wherein the at least one transceiver is further configured to at least communicate the information associated with the unique identification code to a user.

4. The system in accordance with claim 2 wherein the at least one transceiver is characterized by being portable by hand or otherwise accompanying the user.

5. The system in accordance with claim 4 wherein the at least one transceiver is further configured to at least communicate the information associated with the unique identification code to a user.

6. The system in accordance with claim 1 wherein the communication network is a wireless area network.

7. The system in accordance with claim 6 wherein the at least one transceiver is further configured to at least communicate the information associated with the unique identification code to a user.

8. The system in accordance with claim 6 wherein the at least one transceiver is characterized by being portable by hand or otherwise accompanying the user.

9. The system in accordance with claim 8 wherein the at least one transceiver is further configured to at least communicate the information associated with the unique identification code to a user.

10. The system in accordance with claim 1 wherein the at least one label is further configured to obtain electrical power from either (a) electrical mains wiring, (b) an energy storage/production device, or (c) and energy storage device in operable combination with a photovoltaic device, and to remain dormant until receiving an activating signal from the at least one transceiver, and wherein the at least one transceiver is further configured to transmit the activating signal to the at least one label to cause the at least one label to be active.

11. A method for enabling communication of label-specific information through a communication network in communication with a computer server, which method comprises:
a) designating a plurality of specific locations in an environment by disposing a plurality of labels, each label being (i) disposed on an object in the environment with which a unique identification code is associated, wherein the object is either stationary or moving or at times stationary and at times moving, and (ii) configured to transmit at least one lightwave signal indicative of the unique identification code;
b) providing at least one mobile transceiver adapted to receive the lightwave signal indicative of the unique identification code, to process the lightwave signal to obtain the unique identification code, and to communicate through the communication network with the server; and
c) providing to the server a computer database configured to correlate the unique identification code with information specific to the respective object in the environment, the server being accessible through the communication network and configured to download the specific information correlated with the respective object from the database to the at least one transceiver.

12. The method in accordance with claim 11 wherein the communication network is a telecommunication network.

13. The method in accordance with claim 12 which further comprises configuring the at least one transceiver to communicate downloaded specific information for the respective object to a user.

14. The method in accordance with claim 13 which further comprises configuring the transceiver to communicate with the user by (I) displaying the information on a graphic display, (II) communicating the information by generating an audible signal, (III) tactile representation or (IV) any two or more of the foregoing.

15. The method in accordance with claim 11 wherein the communication network is a wireless area network.

16. The method in accordance with claim 15 which further comprises configuring the at least one transceiver to communicate downloaded specific information for the respective object to a user.

17. The method in accordance with claim 16 which further comprises configuring the transceiver to communicate with the user by (I) displaying the information on a graphic display, (II) communicating the information by generating an audible signal, (III) tactile representation or (IV) any two or more of the foregoing.

18. A method for communicating label-specific information through a communication network, which method comprises:
(A) transmitting a lightwave signal indicative of a unique identification code by at least one of a plurality of labels, each label being disposed on an object in the environment with which the unique identification code is associated, wherein the object is either stationary or moving or at times stationary and at times moving;
(B) receiving the lightwave signal by at least one transceiver from the at least one label, each transceiver being configured to process the lightwave signal to obtain the unique identification code;
(C) transmitting a first radio frequency signal by the at least one transceiver to a computer network comprised of at least one computer server, the first radio frequency signal being indicative of the unique identification code, and the at least one transceiver and the computer network being in wireless radio communication;
(D) receiving the first radio frequency signal by the at least one server of the computer network from the at least one transceiver, the at least one server being configured to (1) obtain the unique identification code from the first radio frequency signal, (2) process the unique identification code to link the at least one server to a computer database having information associated with the unique identification number, and (3) obtain the information from the database;
(E) transmitting a second radio frequency signal by the at least one server to the at least one transceiver, which second radio frequency signal is indicative of processed database information associated with the object in the environment; and
(F) receiving the second radio frequency signal by the at least one transceiver from the at least one server, wherein the at least one transceiver is configured to obtain the processed database information from the second radio frequency signal and to cause the processed database information to be communicated to a user.

19. The method in accordance with claim 18 wherein the communication network is a telecommunication network.

20. The method in accordance with claim 18 wherein the communication network is a wireless area network.

21. A system comprised of a computer database, at least one transceiver, and a plurality of labels, each label being (i) disposed on an object the environment with which a unique identification code is associated, wherein the object is either stationary or moving or at times stationary and at times moving, and (ii) configured to transmit at least one lightwave signal indicative of the unique identification code, whereby the at least one transceiver is configured to receive the at least one lightwave signal, to process the lightwave signal to obtain the unique identification code, and to communicate through a communication network with the computer database to download information associated with the unique identification code obtained.
